(19) United States
(12) Patent Application Publication
(10) Pub. No.: US 2026/0073042 A1
(43) Pub. Date: Mar. 12, 2026

(54) AUTOMATED INTRUSION DETECTION THROUGH DIAGNOSTIC DATA ANALYSIS

(71) Applicant: International Business Machines Corporation, Armonk, NY (US)

(72) Inventors: Michael Page KASPER, Wappingers Falls, NY (US); Bryan CHILDS, Poughkeepisie, NY (US); Andrew C. M. HICKS, Highland, NY (US); Diane Marie STAMBONI, Poughkeepsie, NY (US); Joshua David STEEN, Fishkill, NY (US); Christopher V. DEROBERTIS, Hopewell Junction, NY (US)

(21) Appl. No.: 18/830,769

(22) Filed: Sep. 11, 2024

(51) Int. Cl. G06F 21/55

(52) U.S. Cl. CPC G06F 21/554

(57) ABSTRACT

Identifying an intrusion (e.g., a malicious intrusion) into a computing system is a challenging problem, because there is limited data available about what an intrusion would look like while it is progress. In one embodiment, input data reflecting operation of an operating system is received and a potential security intrusion for the operating system using the input data is identified by at least one of determining, based on the input data, that a first number of privilege changes exceeds a first threshold value or determining, based on the input data, that a second number of occurrences of an event, for a first user, exceeds a second threshold. An action can be taken to alleviate the potential security intrusion.

### BACKGROUND

The present invention relates to computing systems, and more specifically, to computer security.

### SUMMARY

One embodiment herein is a method that includes receiving input data reflecting operation of an operating system, identifying a potential security intrusion for the operating system using the input data that includes at least one of determining, based on the input data, that a first number of privilege changes exceeds a first threshold value or determining, based on the input data, that a second number of occurrences of an event, for a first user, exceeds a second threshold. The method also includes taking an action to alleviate the potential security intrusion.

One embodiment herein is a non-transitory computer program product that includes one or more non-transitory computer readable media containing, in any combination, computer program code that, when executed by operation of any combination of one or more processors, performs operations. The operations includes receiving input data reflecting operation of an operating system and identifying a potential security intrusion for the operating system using the input data that includes at least one of determining, based on the input data, that a first number of privilege changes exceeds a first threshold value or determining, based on the input data, that a second number of occurrences of an event, for a first user, exceeds a second threshold. The operations also include taking an action to alleviate the potential security intrusion.

One embodiment herein is a system that includes one or more processors and one or more memories storing a program, which, when executed on any combination of the one or more processors, performs operations. The operations includes receiving input data reflecting operation of an operating system and identifying a potential security intrusion for the operating system using the input data that includes at least one of determining, based on the input data, that a first number of privilege changes exceeds a first threshold value or determining, based on the input data, that a second number of occurrences of an event, for a first user, exceeds a second threshold. The operations also include taking an action to alleviate the potential security intrusion.

### BRIEF DESCRIPTION OF THE DRAWINGS

FIG. 1 illustrates a computing environment for automated intrusion detection, according to one embodiment.

FIG. 2 illustrates a block diagram for automated intrusion detection, according to one embodiment.

FIG. 3 illustrates a flowchart for automated intrusion detection, according to one embodiment.

FIG. 4 illustrates a further flowchart for automated intrusion detection, according to one embodiment.

### DETAILED DESCRIPTION

Identifying an intrusion (e.g., a malicious intrusion) into a computing system is a challenging problem, because there is limited data available about what an intrusion would look like while it is progress. This makes it difficult to model the events that would occur and to watch out for specific attack patterns. In an embodiment, a solution could use behavior analysis and identify changes in user behavior (e.g., using machine learning (ML) or other suitable techniques). But this is error prone, because users change their behavior constantly for legitimate reasons, so analysis of behavior changes results in many false positives.

Alternatively, a computing system can identify an intrusion by detecting anomalous behavior of the system once the attack has been successful. For example, large increases in CPU usage, I/O bottlenecks with large amounts of data being updated, read, or written, or thousands of error messages of odd origins displayed to an operator, could indicate an intrusion. But generally identifying these indicators of anomalous behavior is too little too late, because they appear after the intrusion attack has succeeded.

One or more techniques described here use existing data (e.g., captured by an operating system (OS)) to spot thresholds of suspicious activity that are an indication of an attack, very quickly after the attack has commenced (e.g., minutes or hours after the behavior is observed and well before the timeframe it would typically take for an intrusion to be detected). For example, an intrusion detection system can analyze any combination of available data, including system dumps, log rec records, syslog data, system records (e.g., system authorization facility (SAF) records in a z/OS system), management records (e.g., system management facility (SMF) records in a z/OS system, including SMF records for I/O), security calls, and network activity.

In an embodiment, two different aspects can be observed from analyzing this data (e.g., on a per-user basis). First, the number of records for specific events and event types per user can be recorded and thresholds can be set (e.g., with global and individual limits), so that an alert is triggered if the threshold is exceeded. An example of this could be that large transfers of data or modifications of data could be flagged as suspicious, and if a certain user or process uses a large amount of data an individual limit could be set so that user would not be flagged as suspicious unless their amount of I/O or network data was higher. Another example could be failed logon attempts. Even though a user might be revoked due to excessive attempts it may not trigger an action, even if attempts continue after revocation. This embodiments herein will take action. Second, a change in security checks for specific resources from pass to fail or fail to pass could indicate a privilege escalation or a denial of service has occurred, either of which might require a rapid response. This could be accomplished by recording details information from a trace (e.g., an SAF trace) such as usernames and resource names, as well as pass and fail counts for each resource, to determine if permissions changed.

Alternatively, ML could be used (e.g., a trained ML model) for intrusion detection. But this has several disadvantages compared with data analysis techniques discussed herein. For example, inference using ML is typically untraceable, or very difficult to trace. This makes determining whether a given intrusion inference is accurate, because the reason for the inference is difficult to discern. One or more techniques discussed herein can provide data supporting the detection of the potential intrusion, allowing for much more rapid and easier determination of the accuracy of the detection.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a detection service 152 for automated intrusion detection. In addition to block 152, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 152, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

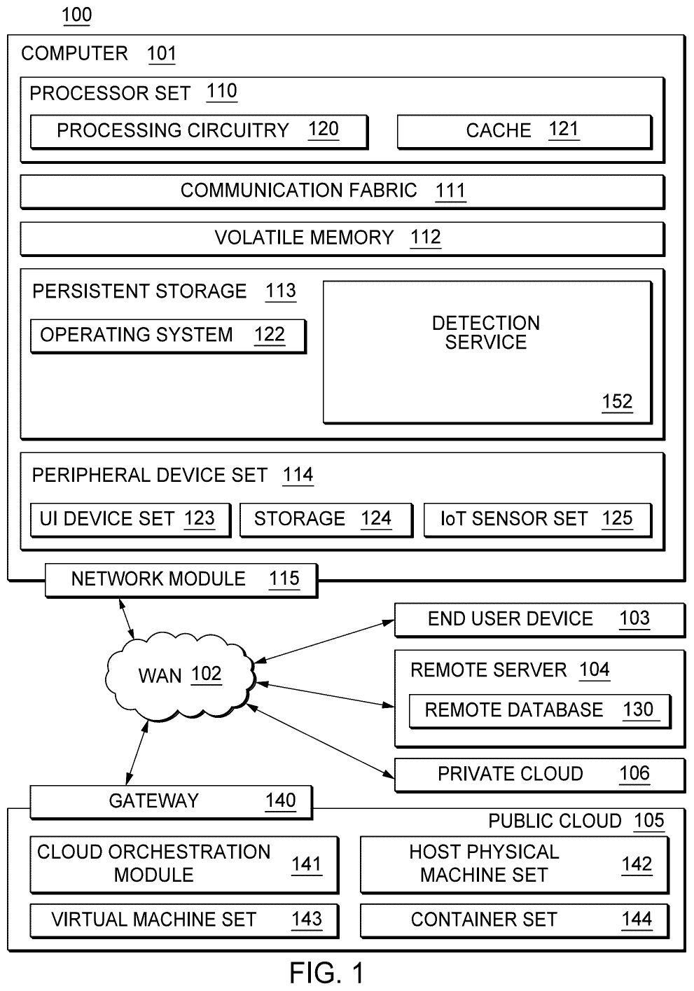

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 152 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 152 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

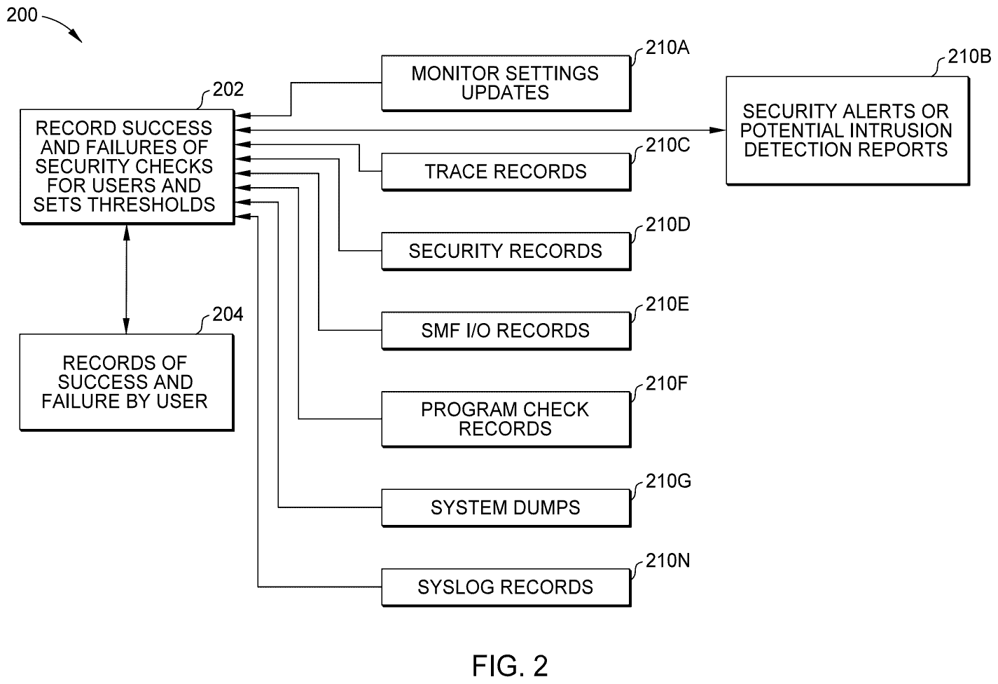

FIG. 2 illustrates a block diagram 200 for intrusion detection, according to one embodiment. At block 202 a detection service (e.g., the detection service 152 illustrated in FIG. 1) records successes and failures of security checks for users, and sets thresholds. For example, the detection service can analyze records of success and failure by a user 204, and can set appropriate threshold values. In an embodiment, these thresholds can be set by default, can be set manually (e.g., by a human administrator) prior to operation, can be set manually during operation (e.g., using a suitable user interface), can be set automatically using a suitable rules-based technique, can be set automatically using a suitable ML model (e.g., a supervised ML model trained using historical data), or using any other suitable technique.

In an embodiment, the detection service can identify any suitable data recorded in association with the records of success and failure by a user. The data can include monitor settings updates 210A, security alerts or potential intrusion detection reports 210B, trace records 210C (e.g., SAF trace records), security records 210D (e.g., SMF security records), I/O records 210E (e.g., SMF I/O records), program check records 210F (e.g., logrec records), system dumps 210G, syslog records 210N, or any other suitable data. For example, the detection service can identify system dumps or environmental record editing and printing (EREP) data. System diagnostic data in the form of system dumps or EREP data can contain details of problems which occurred on a z/OS system.

As another example, the detection service can trace security calls. Many authorized services check the authority level or security settings of the caller to determine what functions are allowed to be performed, or perform different functions depending on the combination of authority levels of the caller. By tracing the security calls that are made to check for specific authorities, the detection service can compile a list of the relevant security settings or profiles of the caller. This information could be aggregated and analyzed. These and other system trace facilities can be used for data analysis to detect an attempted intrusion.

Further, the detection service can use specific techniques for analyzing that data to determine if it proves there was malicious activity taking place on the system, for example an unexplained change in the security settings or attributes of a user, attempting to bypass security and access or overwrite data that should not be overwritten or branch to code that should not be executed. In an embodiment, threshold counts for error events or I/O and network activity or errors could be used, as well as program check analysis to identify signs of suspicious activity.

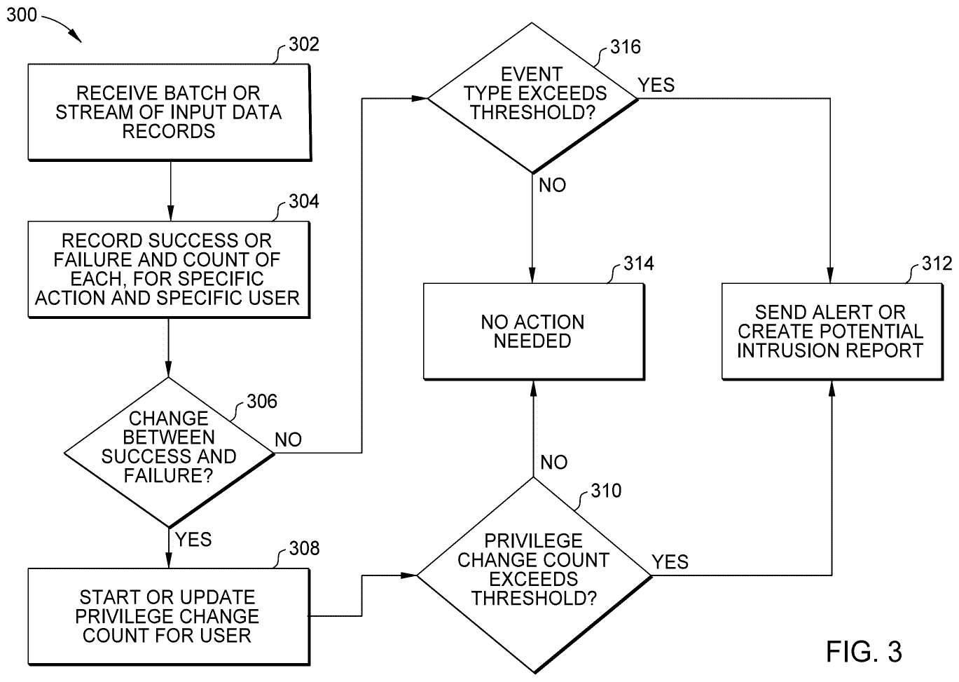

FIG. 3 illustrates a flowchart 300 for intrusion detection, according to one embodiment. At block 302, a detection service (e.g., the detection service 152 illustrated in FIG. 1 or any other suitable software service) receives a batch or stream of input data records. In an embodiment, the data records are recorded in files (e.g., maintained in a suitable local or remote repository), and the detection service can retrieve the files (e.g., in batches). For example, the detection service can retrieve relevant files at specified intervals, upon the occurrence of specified actions, or using any other suitable technique. Alternatively, or in addition, the data can be streaming and a data stream can be provided to the detection service.

At block 304, the detection service records the success or failure, and the count of success or failure, for each specific action and specific user. In an embodiment, the detection service records this information in any suitable electronic repository, including a local or remote storage system (e.g., a cloud storage system), an electronic database, or any other suitable electronic repository.

At block 306, the detection service determines whether there has been a change between success and failure of security checks (e.g., for a particular action). For example, the detection service can identify the first security check success after previous failures for a given action. As another example, the detection service can identify the first security check failure after previous successes for a given action. In an embodiment, a change in security checks for specific resources from pass to fail or fail to pass could indicate a privilege escalation or a denial of service has occurred, either of which might indicate an intrusion. If the detection service identifies a change between security check success and failure for a particular action, the flow proceeds to block 308.

In an embodiment, the detection service identifies the change in security check success or failure by parsing the input data received at block 302. For example, the detection service can identify recorded information from a trace (e.g., an SAF trace), such as usernames and resource names, as well as pass and fail counts for each resource, to identify a change.

At block 308, the detection service starts or updates a privilege change count for a given user. At block 310, the detection service determines whether the privilege change count exceeds a threshold value. In an embodiment, as discussed above, the privilege change count threshold can be set by default, can be set manually (e.g., by a human administrator) prior to operation, can be set manually during operation (e.g., using a suitable user interface), can be set automatically using a suitable rules-based technique, can be set automatically using a suitable ML model (e.g., a supervised ML model trained using historical data), or using any other suitable technique.

If the privilege change count exceeds the threshold value, the flow proceeds to block 312. At block 312 the detection service sends an alert or creates a potential intrusion report. This is merely an example. As another example, the detection service can modify operation for a user related to the intrusion (e.g., freezing the user, deleting the user, or taking any other suitable action for the user), or can take any other suitable action.

Returning to block 310, if the detection service determines that the privilege change count does not exceed the threshold, the flow proceeds to block 314. At block 314 the detection service determines that no action is needed.

Returning to block 306, if the detection service determines that there has not been a change between success and failure, the flow proceeds to block 316. At block 316 the detection service determines whether the event type exceeds a threshold (e.g., on a per-user basis). For example, the detection service can determine whether a number of occurrences of a given event type, for a given user, exceed a threshold for that event type. If so, the flow proceeds to block 312 and the detection service sends an alert or creates a potential intrusion report. If not, the flow proceeds to block 314 and the detection service determines that no action is needed. In an embodiment, the detection service can use a global threshold (e.g., across all users or a set of multiple users), an individual threshold (e.g., per-user), or both.

In an embodiment, as discussed above, the event type thresholds can be set by default, can be set manually (e.g., by a human administrator) prior to operation, can be set manually during operation (e.g., using a suitable user interface), can be set automatically using a suitable rules-based technique, can be set automatically using a suitable ML model (e.g., a supervised ML model trained using historical data), or using any other suitable technique. Further, in an embodiment, the event type thresholds are higher than the privilege escalation threshold discussed above in relation to block 310. For example, privilege escalation may occur significantly less frequently in normal operation, so that a smaller number of privilege escalations (e.g., compared with event occurrences) indicates a potential intrusion.

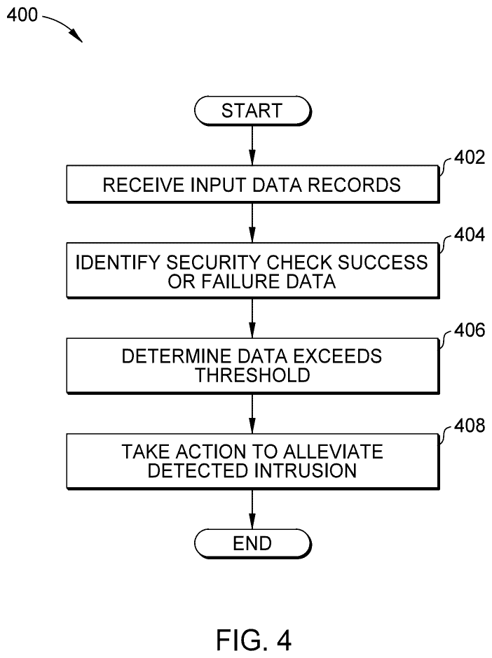

FIG. 4 illustrates a further flowchart 400 for intrusion detection, according to one embodiment. At block 402, a detection service (e.g., the detection service 152 illustrated in FIG. 1) receives input data records. For example, as discussed above in relation to FIGS. 2-3, the detection service can receive input data relating to successes or failures by a user in running a specific task or function.

At block 404, the detection service identifies security check success or failure data. For example, as discussed above in relation to block 306 illustrated in FIG. 3, the detection service can use a change between security check success and failure (e.g., security check successes followed by a failure or security check failures followed by a success) to identify a potential intrusion.

At block 406, the detection service determines that data exceeds a threshold value. For example, as discussed above in relation to block 310, the detection service can determine that a privilege change count exceeds a threshold. As another example, as discussed above in relation to block 316, the detection service can determine that an event type (e.g., a number of occurrences of an event type) exceeds a threshold.

At block 408, the detection service takes an action to alleviate a detected intrusion. For example, as discussed above in relation to block 312 illustrated in FIG. 3, the detection service can send an alert or create a potential intrusion report. As another example, the detection service can modify operation for a user related to the intrusion (e.g., freezing the user, deleting the user, or taking any other suitable action for the user), or take any other suitable action.

While the foregoing is directed to embodiments of the present invention, other and further embodiments of the invention may be devised without departing from the basic scope thereof, and the scope thereof is determined by the claims that follow.

What is claimed is:

1. A method comprising:
receiving input data reflecting operation of an operating system;
identifying a potential security intrusion for the operating system using the input data, comprising at least one of:
(i) determining, based on the input data, that a first number of privilege changes exceeds a first threshold value; or
(ii) determining, based on the input data, that a second number of occurrences of an event, for a first user, exceeds a second threshold; and
taking an action to alleviate the potential security intrusion.

2. The method of claim 1, wherein identifying the potential security intrusion for the operating system comprises determining, based on the input data, that a first number of privilege changes exceeds a first threshold value, further comprising:
identifying a change between success and failure of a security check for a first action of a plurality of actions associated with the operating system.

3. The method of claim 2, wherein identifying the change between success and failure of a security check for a first action of the plurality of actions comprises at least one of:
(i) identifying a plurality of security check successes for the first action followed by a security check failure, or
(ii) identifying a plurality of security check failures for the first action followed by a security check success.

4. The method of claim 2, further comprising:
parsing the input data to identify the change between success and failure of the security check for the first action of the plurality of actions.

5. The method of claim 1, wherein the input data comprises at least one of: (i) monitor settings update data, (ii) security alert data, (iii) potential intrusion detection report data, (iv) trace records, (v) security records, (vi) input output (I/O) records, (v) program check records, (vi) logrec records, (vii) system dumps, (viii) syslog records, or (ix) network activity data.

6. The method of claim 5, wherein the input data comprises both of: (vi) I/O records and (ix) network activity data.

7. The method of claim 1, wherein taking the action to alleviate the potential security intrusion comprises at least one of: (i) sending an alert or (ii) generating a potential intrusion report.

8. The method of claim 1, wherein taking the action to alleviate the potential security intrusion comprises identifying a user associated with the potential intrusion and modifying operation for the user.

9. The method of claim 8, wherein modifying operation for the user comprises at least one of: (i) deleting the user or (ii) freezing the user.

10. A non-transitory computer program product comprising:
one or more non-transitory computer readable media containing, in any combination, computer program code that, when executed by operation of any combination of one or more processors, performs operations comprising:
receiving input data reflecting operation of an operating system;
identifying a potential security intrusion for the operating system using the input data, comprising at least one of:
(i) determining, based on the input data, that a first number of privilege changes exceeds a first threshold value; or
(ii) determining, based on the input data, that a second number of occurrences of an event, for a first user, exceeds a second threshold; and
taking an action to alleviate the potential security intrusion.

11. The non-transitory computer program product of claim 10, wherein identifying the potential security intrusion for the operating system comprises determining, based on the input data, that a first number of privilege changes exceeds a first threshold value, further comprising:
identifying a change between success and failure of a security check for a first action of a plurality of actions associated with the operating system.

12. The non-transitory computer program product of claim 11, wherein identifying the change between success and failure of a security check for a first action of the plurality of actions comprises at least one of:
(i) identifying a plurality of security check successes for the first action followed by a security check failure, or
(ii) identifying a plurality of security check failures for the first action followed by a security check success.

13. The non-transitory computer program product of claim 10, wherein the input data comprises at least one of: (i) monitor settings update data, (ii) security alert data, (iii) potential intrusion detection report data, (iv) trace records, (v) security records, (vi) input output (I/O) records, (v) program check records, (vi) logrec records, (vii) system dumps, (viii) syslog records, or (ix) network activity data.

14. The non-transitory computer program product of claim 10, wherein taking the action to alleviate the potential security intrusion comprises at least one of: (i) sending an alert or (ii) generating a potential intrusion report.

15. The non-transitory computer program product of claim 10, wherein taking the action to alleviate the potential security intrusion comprises identifying a user associated with the potential intrusion and modifying operation for the user.

16. A system, comprising:
one or more processors; and
one or more memories storing a program, which, when executed on any combination of the one or more processors, performs operations, the operations comprising:
receiving input data reflecting operation of an operating system;
identifying a potential security intrusion for the operating system using the input data, comprising at least one of:
(i) determining, based on the input data, that a first number of privilege changes exceeds a first threshold value; or
(ii) determining, based on the input data, that a second number of occurrences of an event, for a first user, exceeds a second threshold; and
taking an action to alleviate the potential security intrusion.

17. The system of claim 16, wherein identifying the potential security intrusion for the operating system comprises determining, based on the input data, that a first number of privilege changes exceeds a first threshold value, further comprising:
identifying a change between success and failure of a security check for a first action of a plurality of actions associated with the operating system.

18. The system of claim 17, wherein identifying the change between success and failure of a security check for a first action of the plurality of actions comprises at least one of:
(i) identifying a plurality of security check successes for the first action followed by a security check failure, or
(ii) identifying a plurality of security check failures for the first action followed by a security check success.

19. The system of claim 16, wherein the input data comprises at least one of: (i) monitor settings update data, (ii) security alert data, (iii) potential intrusion detection report data, (iv) trace records, (v) security records, (vi) input output (I/O) records, (v) program check records, (vi) logrec records, (vii) system dumps, (viii) syslog records, or (ix) network activity data.

20. The system of claim 16, wherein taking the action to alleviate the potential security intrusion comprises at least one of: (i) sending an alert, (ii) generating a potential intrusion report, or (iii) identifying a user associated with the potential intrusion and modifying operation for the user.
